(19) United States
(12) Patent Application Publication
(10) Pub. No.: US 2025/0078286 A1
(43) Pub. Date: Mar. 6, 2025

(54) APPARATUS AND METHOD WITH QUANTIZING OF A TARGET TRACKING MODEL

(71) Applicant: SAMSUNG ELECTRONICS CO., LTD., Suwon-si (KR)

(72) Inventors: Zao YAO, Xi'an (CN); Ju Hwan SONG, Suwon-si (KR); Ying MIN, Xi'an (CN); Byung In YOO, Suwon-si (KR); Changbeom PARK, Suwon-si (KR); YunHao ZHANG, Xi'an (CN); Junchen REN, Xi'an (CN); Yuanzhang YAO, Xi'an (CN); Sanqi LI, Xi'an (CN)

(73) Assignee: SAMSUNG ELECTRONICS CO., LTD., Suwon-si (KR)

(21) Appl. No.: 18/803,352

(22) Filed: Aug. 13, 2024

(30) Foreign Application Priority Data
Aug. 30, 2023 (CN) 202311107931.7
May 3, 2024 (KR) 10-2024-0059304

(51) Int. Cl. G06T 7/246; G06T 7/80; G06V 10/28; G06V 10/42; G06V 10/80

(52) U.S. Cl. CPC G06T 7/246; G06T 7/80; G06V 10/28; G06V 10/42; G06V 10/806

(57) ABSTRACT

An apparatus and method for quantizing a transformer-based target tracking model are provided. The method includes obtaining a transformer-based target tracking model including a template branch, a search branch, a stitching module, and a first transformer module, generating an optimized target tracking model by removing the stitching module from the transformer-based target tracking model and dividing the first transformer module into a second transformer module and a third transformer module, and generating a quantization model corresponding to the optimized target tracking model by quantizing the divided second transformer module independently of quantizing the divided third transformer module.

### CROSS-REFERENCE TO RELATED APPLICATIONS

This application claims the benefit under 35 USC § 119 (a) of Chinese Patent Application No. 202311107931.7, filed on Aug. 30, 2023, in the China National Intellectual Property Administration, and Korean Patent Application No. 10-2024-0059304, filed on May 3, 2024, in the Korean Intellectual Property Office, the entire disclosures of which are incorporated herein by reference for all purposes.

### BACKGROUND

### 1. Field

The following description relates to a field of computer vision technology, and more particularly, to quantizing and tracking a target tracking model.

### 2. Description of Related Art

In recent years, methods based on artificial neural networks, especially convolutional neural networks (CNNs), have achieved great success in many applications, particularly in the field of computer vision. However, convolutional computation fails to utilize context information, since convolutional computation lacks an overall understanding of an image and cannot model a dependency relationship between features. Therefore, researchers have attempted to apply transformer models, generally used in the field of natural language processing, to computer vision tasks.

A transformer is a deep neural network primarily based on a self-attention mechanism. Compared to other network types (e.g., a CNN and a recurrent neural network (RNN)), transformer-based models have shown competitive or better performance in some visual benchmarks. The development and application of transformers in computer vision has become more active.

As deep learning becomes practical as a tool for may aspects of people's lives, intelligence is being installed in many electronic devices such as smartphones, drones, and self-driving vehicles. Neural networks have made progress in many application fields, but the neural networks generally incur high computational costs. Reducing power consumption and time required for neural network inference is key to integrating an industry-leading neural network into an edge electronic device with stringent power and computing constraints.

In particular, a transformer-based target tracking model for tracking a target in a video frame is difficult to integrate into an edge electronic device with stringent power and computing requirements and incurs high computational costs. Accordingly, it is difficult to quickly and accurately track a target through frames of a video sequence using a transformer-based target tracking model in devices such as smartphones, drones, and self-driving vehicles. The above description is information the inventor(s) acquired during the course of conceiving the present disclosure, or already possessed at the time, and is not necessarily art publicly known before the present application was filed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of quantizing a transformer-based target tracking model is performed by one or more processors and includes: obtaining a transformer-based target tracking model including a template branch, a search branch, a stitching module, and a first transformer module; removing the stitching module from the transformer-based target tracking model and dividing the first transformer module into a second transformer module and a third transformer module which together form an optimized target tracking model; and generating a quantized model corresponding to the optimized target tracking model by quantizing the divided second transformer module and by quantizing the divided third transformer module independently of the quantizing of the second transformer, wherein the stitching module receives a first feature output from the template branch and a second feature output from the search branch and stitches the first feature and the second feature into a stitched feature, wherein the second transformer module receives the first feature, and wherein the third transformer module receives the second feature.

The second transformer module may include a first multi-head attention mechanism module that receives a first vector generated by the second transformer module, and the third transformer module may include a second multi-head attention mechanism module that receives a stitched vector obtained by stitching the first vector generated by the second transformer module together with a second vector generated by the third transformer module.

The first vector may include a query vector corresponding to the template branch and a vector obtained by a query corresponding to the template branch, the second vector may include a query vector corresponding to the search branch and a vector obtained by a query corresponding to the search branch, and the stitched vector may include a vector generated by stitching the query vector corresponding to the template branch together with the query vector corresponding to the search branch and a vector generated by stitching the vector obtained by the query corresponding to the template branch together with the vector obtained by the query corresponding to the search branch.

The first multi-head attention mechanism module may receive a query vector corresponding to the template branch, and the second multi-head attention mechanism module may receive a query vector corresponding to the search branch.

The generating of the quantized model may further include: obtaining a calibration data set including a video sequence including frames thereof; configuring a first target calibration data set using a first frame of the video sequence; representing the consecutive frames by selecting one frame from the frames; configuring a second target calibration data set using the selected one frame together with a first vector of the second transformer module, the first vector being generated based on the first target calibration data set; and quantizing the second transformer module based on the first target calibration data set and quantizing the third transformer module based on the second target calibration data set.

A number of the consecutive frames may be based on a frame rate.

The method may further include: obtaining a video sequence as an input to the quantization model; extracting a global template feature by inputting a first frame of the video sequence to a template branch of the quantization model; extracting search features by inputting frames in the video sequence to a search branch of the quantization model; and outputting a target tracking result from the quantized model based on the global template feature and the search features.

A non-transitory computer-readable storage medium stores instructions that, when executed by a processor, cause the processor to perform any of the methods.

In another general aspect, an apparatus for quantizing and tracking a transformer-based target tracking model includes: one or more processors; and memory storing instructions configured to cause the one or more processors to perform a process including: obtaining, by a target tracking model, a transformer-based target tracking model including a template branch, a search branch, a stitching module, and a first transformer module; removing the stitching module from the transformer-based target tracking model and dividing the first transformer module into a second transformer module and a third transformer module which together form an optimized target tracking model; and generating a quantized model corresponding to the optimized target tracking model by quantizing the second transformer module and quantizing the divided third transformer module independently of the quantizing of the divided second transformer module, wherein the stitching module receives a first feature output from the template branch and a second feature output from the search branch and stitches the first feature together with the second feature into a stitched feature, wherein the second transformer module receives the first feature, and wherein the third transformer module receives the second feature.

The second transformer module may include a first multi-head attention mechanism module that receives a first vector generated by the second transformer module, and the third transformer module may include a second multi-head attention mechanism module that receives a stitched vector obtained by stitching the first vector generated by the second transformer module together with a second vector generated by the third transformer module.

The first vector may include a query vector corresponding to the template branch and a vector obtained by a query corresponding to the template branch, the second vector may include a query vector corresponding to the search branch and a vector obtained by a query corresponding to the search branch, and the stitched vector includes a vector generated by stitching the query vector corresponding to the template branch together with the query vector corresponding to the search branch and a vector generated by stitching the vector obtained by the query corresponding to the template branch together with the vector obtained by the query corresponding to the search branch.

The first multi-head attention mechanism module may receive a query vector corresponding to the template branch, and the second multi-head attention mechanism module may receive a query vector corresponding to the search branch.

The process may further: obtain a calibration data set including a video sequence including frames; configures a first target calibration data set using a first frame of the video sequence; represents the frames by selecting one frame from among the frames; configures a second target calibration data set using the selected one frame together with a first vector of the second transformer module, the first vector being generated based on the first target calibration data set; and quantizes the second transformer module based on the first target calibration data set and quantizes the third transformer module based on the second target calibration data set.

A number of the frames may be equal to a value corresponding to a frame rate.

The process may further include: obtaining a video sequence as an input to the quantized model; extracting a global template feature by inputting a first frame of the video sequence into a template branch of the quantization model and extracting search features by inputting frames in the video sequence into a search branch of the quantization model; and outputting a target tracking result from the quantization model based on the global template feature and the search features.

In another general aspect, an electronic device includes: a memory storing instructions; and one or more processors configured by the instructions to: obtain a transformer-based target tracking model including a template branch, a search branch, a stitching module, and a first transformer module; remove the stitching module from the transformer-based target tracking model and divide the first transformer module into a second transformer module and a third transformer module which together form an optimized tracking model; and quantizing the divided second transformer module independently of quantizing the divided third transformer module, receive a first feature output from the template branch and a second feature output from the search branch and stitch the first feature together with the second feature into a stitched feature, wherein the second transformer module receives the first feature, and wherein the third transformer module receives the second feature.

The instructions may further configure the one or more processors to: obtain a video sequence as an input to the quantization model; extract a global template feature by inputting a first frame of the video sequence to a template branch of the quantization model; extract search features by inputting frames in the video sequence to a search branch of the quantization model; and output a target tracking result from the quantized model based on the global template feature and the search features.

Other features and aspects will be apparent from the following detailed description, the drawings, and the claims.

### BRIEF DESCRIPTION OF THE DRAWINGS

FIG. 1 illustrates an example quantization method of a transformer-based target tracking model, according to one or more embodiments.

FIG. 2 illustrates an example of quantizing a second transformer module and quantizing a third transformer module, according to one or more embodiments.

FIG. 3 illustrates an example typical post-training quantization (PTQ) method, according to one or more embodiments.

FIG. 4 illustrates an example transformer-based target tracking model and an optimized target tracking model, according to one or more embodiments.

FIG. 5 illustrates an example of an attention calculation structures, according to one or more embodiments.

FIG. 6 illustrates an example transformer-based target tracking method, according to one or more embodiments.

FIG. 7 illustrates an example of a network corresponding to the transformer-based target tracking method of FIG. 6, according to one or more embodiments.

FIG. 8 illustrates an example quantization apparatus for a transformer-based target tracking model, according to one or more embodiments.

FIG. 9 illustrates an example transformer-based target tracking apparatus, according to one or more embodiments.

FIG. 10 illustrates an example of an electronic device, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

Quantization is described first.

There are two main categories of quantization algorithms.

### 1. Post-Training Quantization (PTQ)

A PTQ algorithm may directly convert 32-bit floating point (FP32) parameters (e.g., weights) of a pre-trained network into fixed-point parameters, and may do so without employing a typical training process. This method is generally data-free or requires only a very small calibration data set, and such data may be obtained very easily without a labeled data set. In addition, this method requires little adjustment of hyper parameters, and thus, the method may be used like a black box with just one application programming interface (API). Quantization of a pre-trained neural network model may be performed in a highly efficient method.

### 2. Quantization-Aware Training (QAT)

A QAT algorithm relies on a method of retraining a neural network using (i) simulation quantization during training and (ii) modeling a source of quantization noise during training. QAT simulates low precision behavior in a forward pass, while a backward pass remains the same. This induces some quantization error which is accumulated in the total loss of the model, which an optimizer tries to reduce by adjusting the parameters accordingly. Such a quantized model may be more accurate than one quantized using PTQ. However, with this increased accuracy may come additional training costs, longer training time, labeled data sets, and a need to search for hyper parameters.

A QAT algorithm may achieve higher accuracy than PTQ, but generally, a PTQ algorithm takes less time. Quantization embodiments and examples described herein mainly relate to a PTQ method of optimizing quantization accuracy of PTQ.

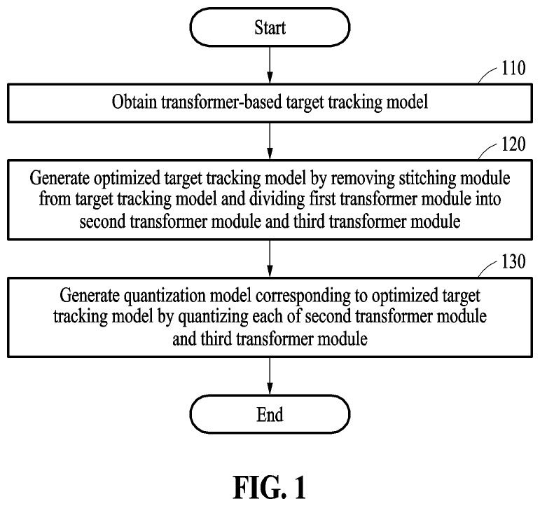

Hereinafter, a quantization method and a target tracking method of a transformer-based target tracking model are described in detail with reference to FIGS. 1 to 10, in combination with examples.

FIG. 1 illustrates an example quantization method of a transformer-based target tracking model, according to one or more embodiments.

Referring to FIG. 1, in operation 110, a quantization method may include obtaining a transformer-based target tracking model.

The transformer-based target tracking model may be configured to track a target in frames of a video sequence. In other words, the transformer-based target tracking model may receive a video frame as an input, may perform a process (e.g., a transformer-based target tracking process) on the video frame, and may track objects (for example, people, vehicles, etc.) in the video frame.

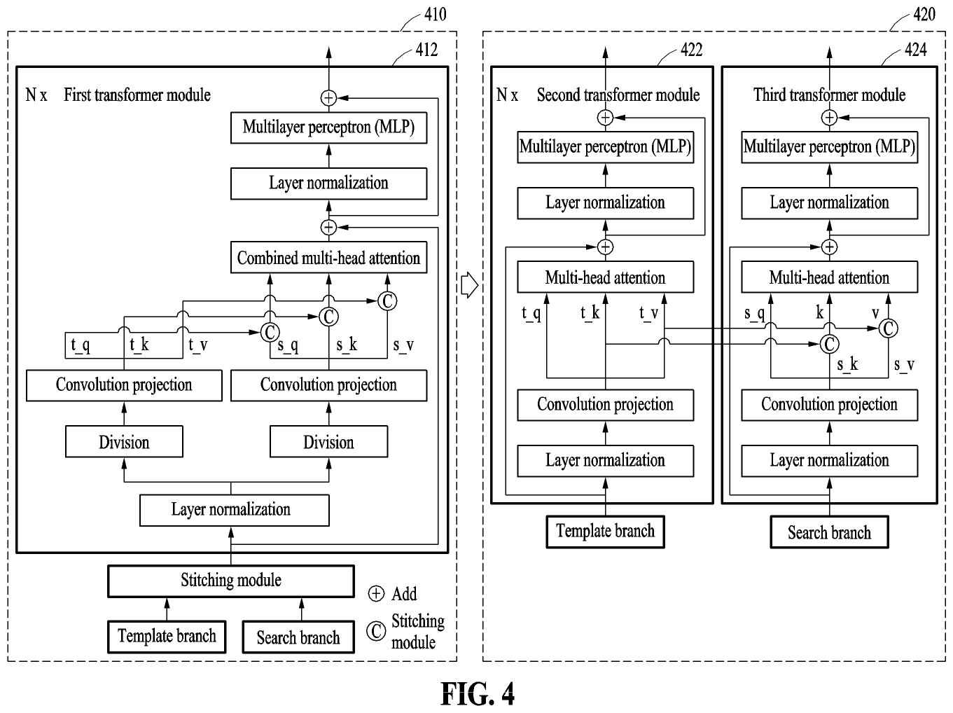

The initial (e.g., non-quantized) transformer-based target tracking model may be any existing transformer-based target tracking model and may be generated and obtained with any known or suitable method. For example, the transformer-based target tracking model may include a template branch, a search branch, a stitching module, and a first transformer module (see, e.g., FIG. 4, left side). The stitching module may receive a first feature output from the template branch and a second feature output from the search branch and may stitch the first feature together with the second feature to form a stitched feature.

The template branch may be used to extract a feature (e.g., the first feature) of a target image, and the target image may be a rectangular area of a target object framed in an initial frame. The search branch may be used to extract a feature (e.g., the second feature) of a search image. The search image may be a rectangular search area of each frame among subsequent frames and may match a target image feature, from among search image features, to localize the target image feature to a location of the target being tracked. The first transformer module may be used to perform target tracking based on the stitched feature.

In operation 120, the quantization method may include generating an optimized target tracking model by removing the stitching module from a target tracking model (e.g., the transformed-based target tracking model) and dividing the first transformer module into a second transformer module and a third transformer module (see, e.g., FIG. 4, right side). The second transformer module may receive the first feature, and the third transformer module may receive the second feature.

Similar to the transformer-based target tracking model of operation 110, the optimized target tracking model of operation 120 may be used to track the target in the video frame. In other words, the optimized target tracking model may receive the video frame as an input, may perform a process (e.g., a transformer-based target tracking process) corresponding to the video frame, and may track objects (for example, people, vehicles, etc.) in the video frame.

The optimized target tracking model may be a result of operation 120 and may be structurally different from the target tracking model, but an output value of the optimized target tracking model may be the same or similar to an output value of the target tracking model.

The second transformer module may include a first multi-head attention mechanism module, and the third transformer module may include a second multi-head attention mechanism module. The first multi-head attention mechanism may receive a first vector generated by the second transformer module, and the second multi-head attention mechanism module may receive a stitched vector obtained by stitching the first vector (generated by the second transformer module) together with the second vector (generated by the third transformer module).

The first multi-head attention mechanism module may process the first vector based on an attention mechanism and may provide an output vector for target tracking. Similarly, the second multi-head attention mechanism module may process the stitched vector based on the attention mechanism and may provide an output vector for target tracking.

The first vector may include a query vector corresponding to the template branch and a vector obtained by a query corresponding to the template branch. The second vector may include a query vector corresponding to the search branch and a vector obtained by a query corresponding to the search branch. The stitched vector may be/include (i) a vector generated by stitching the query vector corresponding to the template branch together with the query vector corresponding to the search branch and (ii) a vector generated by stitching the vector obtained by the query corresponding to the template branch together with the vector obtained by the query corresponding to the search branch.

Selectively, the first multi-head attention mechanism module may further receive the query vector corresponding to the template branch (e.g., “t_q” on the right side of FIG. 4), and the second multi-head attention mechanism module may further receive the query vector corresponding to the search branch.

The first multi-head attention mechanism module may further receive a third vector generated by the second transformer module. The first multi-head attention mechanism module may process the first vector and the third vector based on its attention mechanism and may generate an output vector for target tracking. For example, the third vector may include the query vector corresponding to the template branch. The second multi-head attention mechanism module may receive a fourth vector generated by the third transformer module. The second multi-head attention mechanism module may process the stitched vector and the fourth vector based on its attention mechanism and may provide an output vector for target tracking. For example, the fourth vector may include the query vector corresponding to the search branch.

In operation 130, the quantization method may include generating a quantized model corresponding to the optimized target tracking model by quantizing the divided second transformer module independent of quantizing the divided third transformer module.

Similar to the optimized target tracking model, the quantized model corresponding to the optimized target tracking model may be used to track the target in the video frame. In other words, the quantized model corresponding to the optimized target tracking model may receive the video frame as an input, may perform a process (e.g., a transformer-based target tracking process) corresponding to the video frame, and may track an objects (for example, people, vehicles, etc.) in the video frame. The quantized model may also be referred to as a quantized target tracking model. Compared with the transformer-based target tracking model and the optimized target tracking model, the quantized model may reduce power consumption and computational requirements of system hardware and may decrease degradation of target tracking accuracy stemming from quantization.

In addition, quantization of the second transformer module and the third transformer module may include collecting statistics (e.g., counting) about parameters (e.g., dynamic ranges of weights and/or activation values) corresponding to the second transformer module and parameters (e.g., dynamic range of weights and/or activation values) corresponding to the third transformer module, respectively, based on calibration data. The quantization of the second transformer module may be based on its parameter statistics (e.g., a dynamic range of weights and/or activation values) and the quantization of the third transformer module may be based on its parameter statistics (e.g., a dynamic range of weights and/or activation values) corresponding to the third transformer module. The quantization of the divided second transformer module may be independent of the quantization of the divided third transformer module.

In an existing quantization process of the transformer-based target tracking model, the quantization of the first transformer module may include quantization of data generated by processing data from the template branch and data from the search branch. Since the data from the template branch and the data from the search branch have different sizes and contents, not only are their amounts of data different, but their ranges of data are different. When these pieces of data are connected and quantized together, there may occur a large error in a quantization result obtained with the same set of maximum and minimum values.

On the contrary, the method of quantizing the transformer-based target tracking model according to an example of the present disclosure may include independently quantizing the second transformer module and independently quantizing the third transformer module, under the premise that an output value of the target tracking model is not changed. Accordingly, the target tracking model after being quantized may be more accurately, and an electronic device which employs the thus-quantized transformer-based target tracking model may track a target in video frames more quickly and accurately.

In addition, the quantized model (corresponding to the optimized target tracking model) may receive an input image and may track a target of the input image.

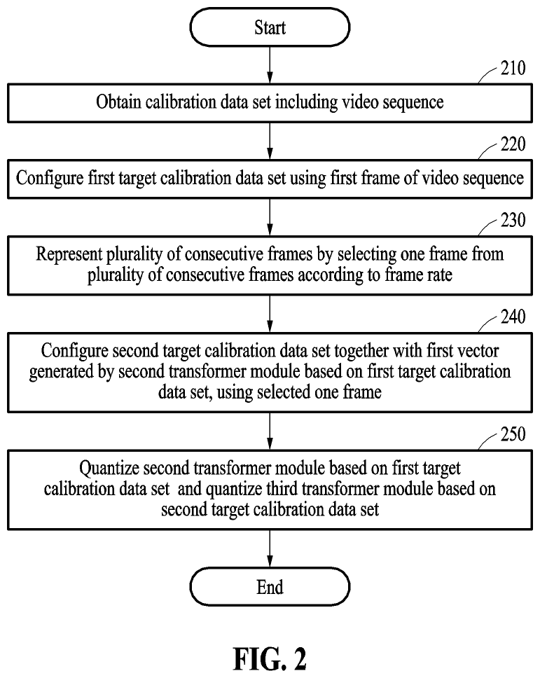

FIG. 2 illustrates an example of quantizing a second transformer module and quantizing a third transformer module, according to one or more embodiments.

Referring to FIG. 2, in operation 210, the quantization method may obtain a calibration data set including a video sequence. The video sequence may include a sequence of consecutive frames. Operations using the video sequence may be repeated for other video sequences.

A large data set designed for target tracking may˜ include many video sequences, including the previously mentioned video sequence. Accordingly, there may be various methods to build the calibration data set (including the video sequence). For example, (i) randomly selecting video sequences by a ratio, (ii) randomly selecting a portion of images of the total video sequence, (iii) randomly selecting video sequences and selecting a portion of images of each video by a ratio, and (iv) selecting a video sequence according to the type of an object that is included in a target among images. However, the examples described above is only an example and the present disclosure is not limited thereto.

In operation 220, the quantization method may configure a first target calibration data set using a first frame of the video sequence.

In operation 230, the quantization method may represent the consecutive frames of the video sequence by selecting, according to a frame rate, one frame from among the consecutive frames.

The number of consecutive frames may be equal to a value corresponding to the frame rate. For example, when the frame rate is 30 frames per second, the number of consecutive frames may be 30 or a value close to 30. In another example, when the frame rate is 25 frames per second, the number of consecutive frames may be 25 or a value close to 25.

Considering the characteristics of a video, the frame rate of most video formats may be a certain value (e.g., 30 frames per second and typically not lower than 25 frames per second). Since 25 images per second is usually satisfactory for object tracking, selecting one of the images per the second case (25 per second) may suffice. Accordingly, in the quantization process, calculation accuracy may be ensured while the amount of calculations is reduced.

For example, the quantization method may include forming images in each video sequence into groups of 25 images/pieces, for example. When random image selection is used, the image may be selected once for each group. Therefore, some test data lists may be selected in a random selection method, an equal-interval selection method, and the like. In addition, the number of selected test data sets may be controlled not to exceed a predetermined ratio (e.g., 1 percent (%)) of the total number of test data sets.

In operation 240, the selected one frame may be used to configure a second target calibration data set together with the first vector generated by the second transformer module based on the first target calibration data set.

For the same video, the first vector generated by the second transformer module of each image/piece of calibration data of the second target calibration data set may not change, since first vectors all use a first frame of a corresponding video as an input to be derived by the second transformer module.

In this method, the first vector may not need to be calculated for each frame but may be calculated for a representative first frame, which may reduce calculation time and improve calculation efficiency.

In operation 250, the second transformer module may be quantized based on the first target calibration data set and the third transformer module may be quantized based on the second target calibration data set.

The quantization method may be any suitable quantization method. As a non-limiting example, the quantization method may be a PTQ quantization method.

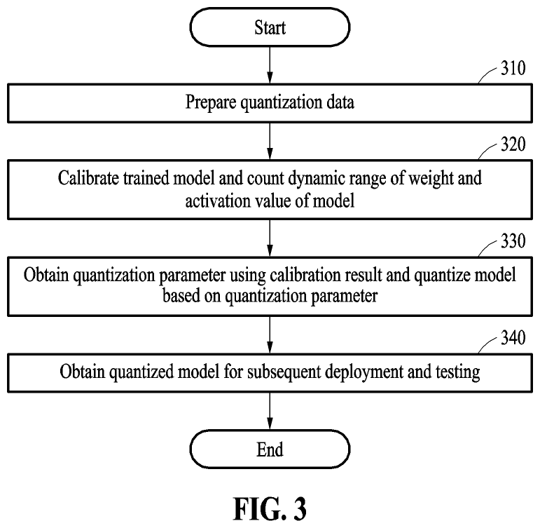

FIG. 3 illustrates an example of a PTQ method, according to one or more embodiments.

Referring to FIG. 3, in operation 310, quantization data (also referred to as calibration data) may be prepared. The quantization data may be a small subset of a larger training data set.

In operation 320, a trained model (e.g., a fully precise model (e.g., FP32)) may be calibrated and a dynamic range of weight and/or activation values of the model may be determined (e.g., by counting the parameters).

In operation 330, a quantization parameter may be obtained using a calibration result and the model may be quantized based on the quantization parameter.

In operation 340, a quantized model (e.g., a fixed point model (e.g., integer (INT) 8)) may be obtained for subsequent deployment and testing.

As noted above, a typical PTQ method may be used, but other quantization methods may be used.

FIG. 4 illustrates an example transformer-based target tracking model and an optimized target tracking model, according to one or more embodiments.

The left portion of FIG. 4 shows a transformer-based target tracking model 410 and the right portion of FIG. 4 shows an optimized target tracking model 420.

The transformer-based target tracking model 410 may include a template branch, a search branch, a stitching module, and a first transformer module. For example, the first transformer module may have a network structure as shown in FIG. 4. However, the present disclosure is not limited thereto, and the first transformer module may have a different network structure, depending on implementation. The transformer-based target tracking model may be implemented with a known/existing model and thus, it should be understood that the transformer-based target tracking model is briefly described to avoid repeated description.

In FIG. 4, t_q represents a query vector generated by the template branch, t_k represents a query vector generated by the template branch, t_v represents a vector obtained by a query generated by the template branch, s_q represents a query vector generated by the search branch, s_k represents a query vector generated by the search branch, and s_v represents a vector obtained by a query generated by the template branch. k represents a query vector combined with vectors of t_k of the template branch and s_k of the search branch and v represent a vector obtained by a query combined with vectors of t_v of the template branch and s_v of the search branch. Nx represents cascade of N times.

Converting the transformer-based target tracking model 410 to the optimized target tracking model 420 may include optimizing the model's network structure by allowing the template branch and the search branch to be calculated as independently as possible. The optimized model structure may be friendly to quantization. Since quantization uses statistics, for example, on the maximum value and the minimum value of each layer of a network based on calibration data, and since the sizes and contents of the template branch and the search branch are different, their respective amounts of data and ranges of data may also be different. When these pieces of data are connected and quantized together (as one set of parameters) and the same set of maximum and minimum values is used, there may occur a large error in a quantization result. Therefore, the template branch may use a second transformer module 422 and the search branch may use a third transformer module 424 such that the template branch and the search branch may be calculated as independently as possible under the premise that an output value of the model does not change. Accordingly, the model after the quantization may be ensured to achieve better accuracy.

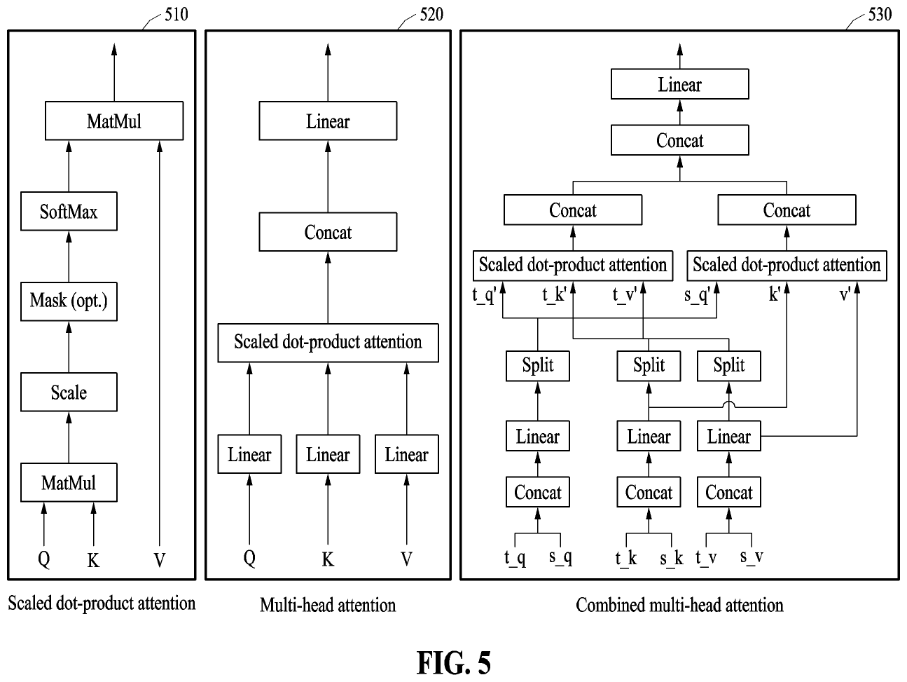

FIG. 5 illustrates an example of an attention calculation structures, according to one or more embodiments.

Generally, there are two types of attention mechanisms. One is an additive attention mechanism and the other is a dot product attention mechanism. A scaled dot product attention 510, a variety of the dot product attention mechanism, is a general dot product attention mechanism added with scales. A scale scales an attention weight to ensure stability of a value. A multi-head attention 520 is proposed by a transformer. The multi-head attention 520 may be a combination of multiple scaled dot product attentions that operate similarly to multiple kernels of a convolutional network. A combined multi-head attention 530 may perform an attention calculation by stitching a template branch and a search branch. The template branch may perform a scaled dot product attention and the search branch may stich t_q and t_v of the template branch and s_q and s_v of the search branch, respectively, to perform a scaled dot-product attention. According to an example of the present disclosure, designing separate calculations considering the mechanism of combined multi-head attention is more friendly to quantization.

In FIG. 5, MatMul is a matrix multiplication operation, Scale is a scaling operation, Mask (opt.) is a masking operation, Linear is a linearization operation, Concat is a cascade operation, and Split is a splitting operation.

FIG. 5 shows example structures of the scaled dot product attention 510, the multi-head attention 520, and the combined multi-head attention 530, but the present disclosure is not limited thereto. The scaled dot product attention 510, the multi-head attention 520, and the combined multi-head attention 530 may have other forms.

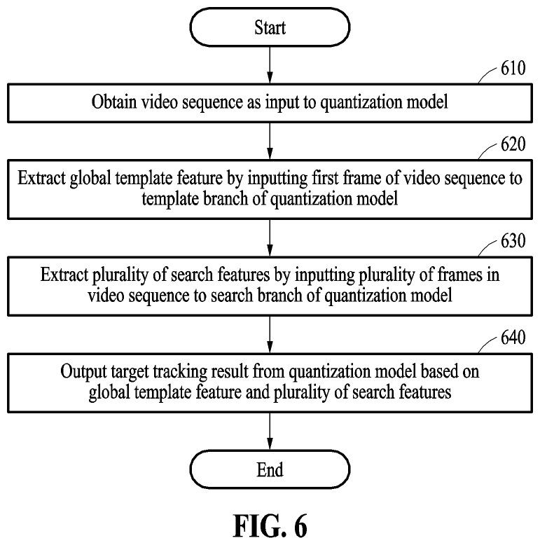

FIG. 6 illustrates an example transformer-based target tracking method, according to one or more embodiments.

Referring to FIG. 6, in operation 610, a video sequence may be obtained as an input to a quantized model. The video sequence may include multiple frames.

In operation 620, a global template feature is extracted by inputting a first frame of the video sequence to the template branch of the quantized model. That is, for a single video sequence, the global template feature may be calculated only once.

In operation 630, search features may be extracted by inputting frames in the video sequence to the search branch of the quantized model. That is, for a single video sequence, the search features may be calculated for each frame.

In operation 640, the target tracking method may include outputting a target tracking result from the quantized model based on the global template feature and the search features.

For a single video sequence, the global template feature may be calculated only once, for example, and a calculation result may be stored in a global variable for search branch calculation, thereby reducing the amount of calculations and improving target tracking speed.

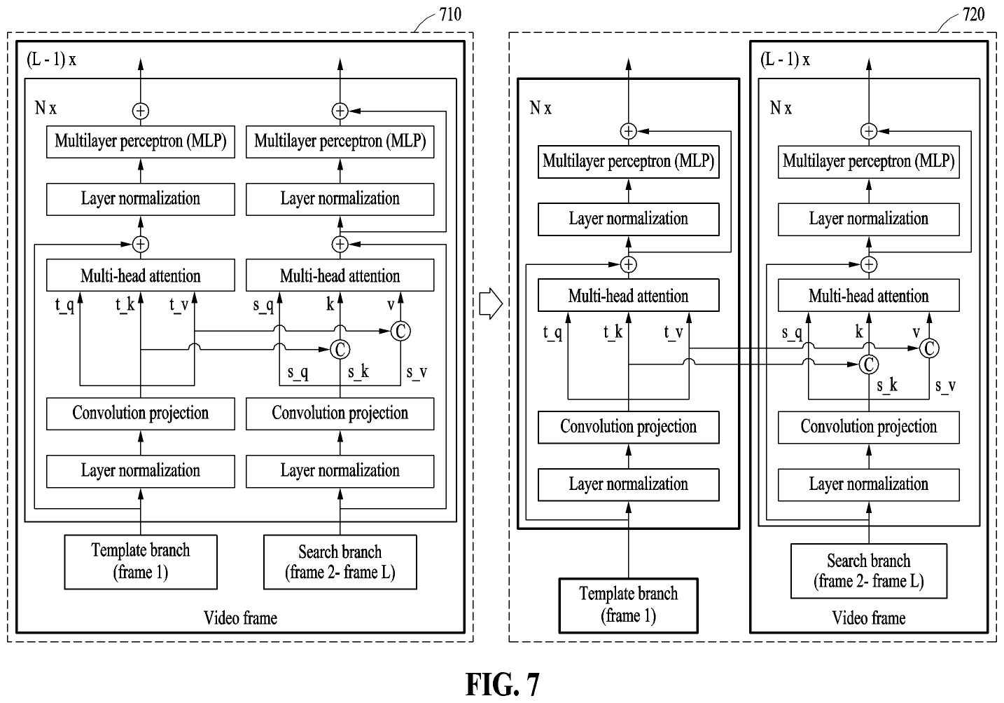

FIG. 7 illustrates an example of a network corresponding to the transformer-based target tracking method of FIG. 6.

The left portion of FIG. 7 shows a network 710 corresponding to a transformer-based target tracking model and the right portion of FIG. 7 shows a separated network 720 corresponding to an optimized target tracking model.

Referring to FIG. 7, a video sequence may include frames from frame 1 to frame L (L is the number of frames).

Since a feature of a template image may need to be calculated only once for any one video sequence, a search image for each subsequent frame may only directly use an already calculated template feature in its calculations. Therefore, in a network, a portion of the network related to a template may be separated from a search portion of the network, the template may be calculated only once, and a calculation result may be stored in a global variable to be used in calculation of the search image. To ensure accuracy of the separated network 720, a quantization parameter after separation may be maintained (kept the same) as a quantization parameter before separation.

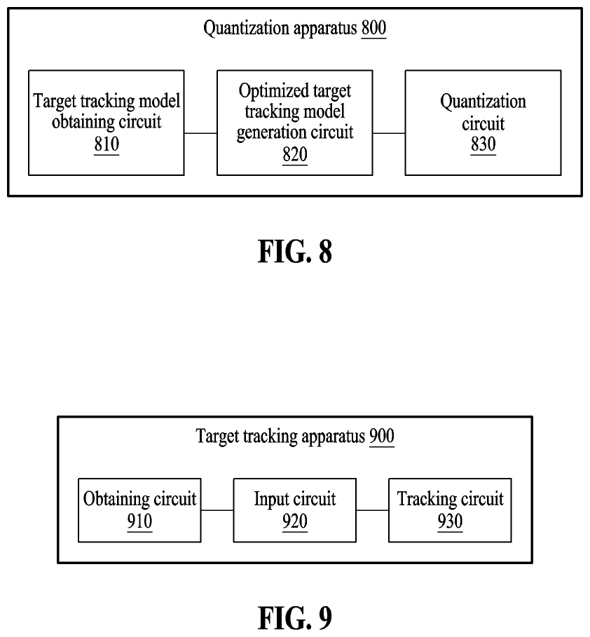

FIG. 8 illustrates an example quantization apparatus for a transformer-based target tracking model, according to one or more embodiments.

Referring to FIG. 8, a quantization apparatus 800 of a transformer-based target tracking model may include a target tracking model obtaining circuit 810, an optimized target tracking model generation circuit 820, and a quantization circuit 830.

The target tracking model obtaining circuit 810 may obtain a transformer-based target tracking model. The target tracking model may include a template branch, a search branch, a stitching module, and a first transformer module. The stitching module may receive a first feature output from the template branch and a second feature output from the search branch and may stitch the first feature together with the second feature into a stitched feature.

The optimized target tracking model generation circuit 820 may generate an optimized target tracking model by removing the stitching module from the target tracking model and dividing the first transformer module into a second transformer module and a third transformer module. The second transformer module may receive the first feature and the third transformer module may receive the second feature.

The quantization circuit 830 may be configured to generate a quantized model corresponding to the optimized target tracking model by quantizing the second transformer module and quantizing the third transformer module.

An obtaining operation performed by the target tracking model obtaining circuit 810, an optimized target tracking model generation operation performed by the optimized target tracking model generation circuit 820, and a quantization operation performed by the quantization circuit 830 are described above with reference to FIGS. 1 to 7.

FIG. 9 illustrates an example transformer-based target tracking apparatus, according to one or more embodiments.

Referring to FIG. 9, a transformer-based target tracking apparatus 900 may include an obtaining circuit 910, an input circuit 920, and a tracking circuit 930.

The obtaining circuit 910 may obtain an input for a quantization model of a video sequence.

The input circuit 920 may extract a global template feature by inputting a first frame of the video sequence into the template branch of the quantization model and may extract search features by inputting frames in the video sequence into the search branch of the quantized model.

The tracking circuit 930 may output a target tracking result from the quantized model based on the global template feature and the search features.

That is, the transformer-based target tracking apparatus 900 may perform any transformer-based target tracking method according to any of the examples or embodiments described here.

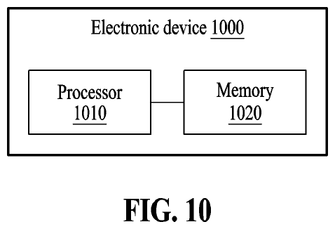

FIG. 10 illustrates an example electronic device, according to one or more embodiments.

Referring to FIG. 10, an electronic device 1000 may include one or more processors 1010 and at least one memory 1020. The at least one memory 1020 may store a computer program in the form of instructions. The computer program or instructions may execute any method described with reference to FIGS. 1 to 7 when executed by the at least one processor 1010. Any method described with reference to FIGS. 1 to 7 may executed by the one or more processors 1010.

Each circuit of the apparatus of the quantization neural network model shown in the present disclosure may be configured by software (processor executable instructions obtained, for example, from source code configured as per the descriptions above), hardware, firmware, or any combination thereof to perform predetermined functions. For example, each circuit may correspond to a dedicated integrated circuit, pure software code, or a circuit combining software and hardware. In addition, at least one function implemented by each circuit may be performed uniformly by components of a physical entity device (e.g., a processor, a client, or a server).

Furthermore, the quantization method of the neural network model described herein may be implemented as a program (or an instruction) recorded on a computer-readable recording medium. For example, according to an example of the present disclosure, a computer-readable storage medium for storing an instruction may be provided. When the instruction is executed by at least one computing device, the instruction may cause the at least one processor 1010 to execute the quantization method of the neural network model.

The computer program of the computer-readable medium described above may be executed in an environment arranged in a computer device such as a client, host, agent device, server, etc. It should be noted that the computer program may be used to perform more specific processes when the computer program performs the above-described operation or additional operations other than the above-described operation. The details of these additional operations and additional processes have been described in the related methods with reference to FIGS. 1 to 7.

It should be noted that each module of the apparatus of the quantization neural network model may entirely depend on the operations of the computer program to implement a corresponding function. That is, since each module corresponds to each operation of a functional architecture of the computer program, the entire system may be called through a dedicated software package (e.g., a lib library) to implement the corresponding function.

Furthermore, each module according to each example of the present disclosure may be implemented by hardware, software, firmware, middleware, microcode, or a combination thereof. When a module is implemented as software, firmware, middleware, or microcode, program code or a code segment used to perform a corresponding operation may be stored in a computer-readable medium such as a storage medium and a processor may read and execute the program code or the code segment.

For example, an example of the present disclosure may be implemented as a computing device including a storage device and a processor. The storage device may store a set of computer-executable instructions and when the set of computer-executable instructions is executed by the processor, the quantization method of a neural network model according to an example of the present disclosure may be executed.

Particularly, the computing device may be deployed on a server or a client and may also be deployed on a node device in a distributed network environment. In addition, the computing device may be a personal computer (PC), a tablet device, a personal digital assistant (PDA), a smartphone, a web application, or other devices for executing the set of instructions.

In this case, the computing device may not need to be a single computing device and may be any device or a combination of circuits capable of individually or jointly executing the instructions (or the set of instructions). The computing device may also be a part of an integrated control system or a system administrator or may be configured as a portable electronic device for interfacing locally or remotely (e.g., via wireless transmission).

In the computing device, the processor may include a central processing unit (CPU), a graphics processing unit (GPU), a programmable logic device, a dedicated processor system, a microcontroller, or a microprocessor. In addition, the processor may also include, for example, but is not limited to, an analog processor, a digital processor, a microprocessor, a multicore processor, a processor array, or a network processor.

Some operations described in the quantization method of the neural network model may be implemented in software and some operations may be implemented in hardware. In addition, these operations may be implemented in a method of combining software and hardware.

The one or more processors may execute instructions or code stored in one of storage components that may further store data. Instructions and data may also be transmitted and received over a network via a network interface device that may use a known transport protocol.

A storage component may be integrated with the processor. For example, random-access memory (RAM) or flash memory may be arranged in an integrated circuit microprocessor. In addition, the storage component may include a separate device such as an external disk drive, a storage array, or any other storage devices that may be used by a database system. The storage component and the processor may be operatively connected or may communicate with each other through, for example, an input/output (I/O) port or a network connection, so that the processor may read files stored in the storage component.

In addition, the computing device may further include a video display (e.g., a liquid crystal display (LCD)) and a user interaction interface (e.g., a keyboard, a mouse, or a touch input device). All components of the computing device may be connected to each other through a bus and/or a network.

The quantization method of the neural network model may be described as various functional blocks or functional diagrams that are connected or combined with each other. However, these functional blocks or functional diagrams may be equally integrated into a single logical device or may operate according to imprecise boundaries.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs or DVDs; magneto-optical media such as optical discs; and hardware devices that are specially configured to store and perform program instructions, such as read-only memory (ROM), RAM, flash memory, and the like. Examples of program instructions include both machine code, such as produced by a compiler, and files containing higher-level code that may be executed by the computer using an interpreter. The above-described devices may be configured to act as one or more software modules in order to perform the operations of the above-described examples, or vice versa.

The computing apparatuses, the models, the processors, the memories, the displays, the information output system and hardware, the storage devices, and other apparatuses, devices, units, modules, and components described herein with respect to FIGS. 1-10 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-10 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RW, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method of quantizing a transformer-based target tracking model, the method performed by one or more processors and comprising:
obtaining a transformer-based target tracking model comprising a template branch, a search branch, a stitching module, and a first transformer module;
removing the stitching module from the transformer-based target tracking model and dividing the first transformer module into a second transformer module and a third transformer module which together form an optimized target tracking model; and
generating a quantized model corresponding to the optimized target tracking model by quantizing the second transformer module and by quantizing the divided third transformer module independently of the quantizing of the divided second transformer,
wherein the stitching module receives a first feature output from the template branch and a second feature output from the search branch and stitches the first feature and the second feature into a stitched feature,
wherein the second transformer module receives the first feature, and
wherein the third transformer module receives the second feature.

2. The method of claim 1, wherein
the second transformer module comprises a first multi-head attention mechanism module that receives a first vector generated by the second transformer module, and
the third transformer module comprises a second multi-head attention mechanism module that receives a stitched vector obtained by stitching the first vector generated by the second transformer module together with a second vector generated by the third transformer module.

3. The method of claim 2, wherein
the first vector comprises a query vector corresponding to the template branch and a vector obtained by a query corresponding to the template branch,
the second vector comprises a query vector corresponding to the search branch and a vector obtained by a query corresponding to the search branch, and
the stitched vector comprises a vector generated by stitching the query vector corresponding to the template branch together with the query vector corresponding to the search branch and a vector generated by stitching the vector obtained by the query corresponding to the template branch together with the vector obtained by the query corresponding to the search branch.

4. The method of claim 2, wherein
the first multi-head attention mechanism module receives a query vector corresponding to the template branch, and
the second multi-head attention mechanism module receives a query vector corresponding to the search branch.

5. The method of claim 1, wherein
the generating of the quantized model further comprises:
obtaining a calibration data set comprising a video sequence comprising frames thereof;
configuring a first target calibration data set using a first frame of the video sequence;
representing the consecutive frames by selecting one frame from the frames;
configuring a second target calibration data set using the selected one frame together with a first vector of the second transformer module, the first vector being generated based on the first target calibration data set; and
quantizing the second transformer module based on the first target calibration data set and quantizing the third transformer module based on the second target calibration data set.

6. The method of claim 5, wherein
a number of the consecutive frames is based on a frame rate.

7. The method of claim 1, further comprising:
obtaining a video sequence as an input to the quantization model;
extracting a global template feature by inputting a first frame of the video sequence to a template branch of the quantization model;
extracting search features by inputting frames in the video sequence to a search branch of the quantization model; and
outputting a target tracking result from the quantized model based on the global template feature and the search features.

8. A non-transitory computer-readable storage medium storing instructions that, when executed by a processor, cause the processor to perform the method of claim 1.

9. An apparatus for quantizing and tracking a transformer-based target tracking model, the apparatus comprising:
one or more processors; and
memory storing instructions configured to cause the one or more processors to perform a process comprising:
obtaining, by a target tracking model, a transformer-based target tracking model comprising a template branch, a search branch, a stitching module, and a first transformer module;
removing the stitching module from the transformer-based target tracking model and dividing the first transformer module into a second transformer module and a third transformer module which together form an optimized target tracking model; and
generating a quantized model corresponding to the optimized target tracking model by quantizing the second transformer module and quantizing the divided third transformer module independently of the quantizing of the divided second transformer module,
wherein the stitching module receives a first feature output from the template branch and a second feature output from the search branch and stitches the first feature together with the second feature into a stitched feature,
wherein the second transformer module receives the first feature, and
wherein the third transformer module receives the second feature.

10. The apparatus of claim 9, wherein
the second transformer module comprises a first multi-head attention mechanism module that receives a first vector generated by the second transformer module, and
the third transformer module comprises a second multi-head attention mechanism module that receives a stitched vector obtained by stitching the first vector generated by the second transformer module together with a second vector generated by the third transformer module.

11. The apparatus of claim 10, wherein
the first vector comprises a query vector corresponding to the template branch and a vector obtained by a query corresponding to the template branch,
the second vector comprises a query vector corresponding to the search branch and a vector obtained by a query corresponding to the search branch, and
the stitched vector comprises a vector generated by stitching the query vector corresponding to the template branch together with the query vector corresponding to the search branch and a vector generated by stitching the vector obtained by the query corresponding to the template branch together with the vector obtained by the query corresponding to the search branch.

12. The apparatus of claim 10, wherein
the first multi-head attention mechanism module receives a query vector corresponding to the template branch, and
the second multi-head attention mechanism module receives a query vector corresponding to the search branch.

13. The apparatus of claim 9, wherein
the process:
obtains a calibration data set comprising a video sequence comprising frames;
configures a first target calibration data set using a first frame of the video sequence;
represents the frames by selecting one frame from among the frames;
configures a second target calibration data set using the selected one frame together with a first vector of the second transformer module, the first vector being generated based on the first target calibration data set; and
quantizes the second transformer module based on the first target calibration data set and quantizes the third transformer module based on the second target calibration data set.

14. The apparatus of claim 13, wherein
a number of the frames is equal to a value corresponding to a frame rate.

15. The apparatus of claim 9, the process further comprising:
obtaining a video sequence as an input to the quantized model;
extracting a global template feature by inputting a first frame of the video sequence into a template branch of the quantization model and extracting search features by inputting frames in the video sequence into a search branch of the quantization model; and
outputting a target tracking result from the quantization model based on the global template feature and the search features.

16. An electronic device comprising:
a memory storing instructions; and
one or more processors configured by the instructions to:
obtain a transformer-based target tracking model comprising a template branch, a search branch, a stitching module, and a first transformer module;
remove the stitching module from the transformer-based target tracking model and divide the first transformer module into a second transformer module and a third transformer module which together form an optimized tracking model; and
quantizing the divided second transformer module independently of quantizing the divided third transformer module,
receive a first feature output from the template branch and a second feature output from the search branch and stitch the first feature together with the second feature into a stitched feature,
wherein the second transformer module receives the first feature, and
wherein the third transformer module receives the second feature.

17. The electronic device of claim 16, wherein the instructions further configure the one or more processors to:
obtain a video sequence as an input to the quantization model;
extract a global template feature by inputting a first frame of the video sequence to a template branch of the quantization model;
extract search features by inputting frames in the video sequence to a search branch of the quantization model; and
output a target tracking result from the quantized model based on the global template feature and the search features.
